(19) United States
(12) Patent Application Publication
(10) Pub. No.: US 2007/0204834 A1
(43) Pub. Date: Sep. 6, 2007

(54) Fuel Injection Valve

(76) Inventor: Bernd Dittus, Tamm (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/630,280

(22) PCT Filed: May 11, 2005
(86) PCT No.: PCT/EP05/52139

§ 371 Date: Dec. 20, 2006

(30) Foreign Application Priority Data
Jul. 2, 2004 (DE) 10 2004 032 181.7

(51) Int. Cl. F02M 69/00

(52) U.S. Cl. 123/445

(57) ABSTRACT

In a fuel injection valve for internal combustion engines, having at least one valve member that is axially displaceable in a valve body and is guided on a guide sleeve and on its end toward the combustion chamber of the engine has a valve sealing face which cooperates with a valve seat face on the valve body, and having at least one injection opening, which is provided downstream of the valve seat face and opens into the combustion chamber of the engine, a thrust rod, which controls the motion of the valve member, is disposed in the guide sleeve.

### PRIOR ART

The invention is based on a fuel injection valve as generically defined by the preamble to claim 1.

One such fuel injection valve has become known for instance from International Patent Disclosure WO 99/19619 A1.

The fuel injection valve known from WO 99/19619 A1 has a valve member, which is axially displaceable in a valve body and is guided slidably displaceably with a sleevelike guide extension on the free end of a sleevelike peg (guide sleeve). The guide sleeve, retained in stationary fashion on the other end, extends into a bore of the valve body, forming an annular chamber. The guide extension of the valve member and the guide sleeve define an inner chamber which is subjected to a control pressure via the through bore in the guide sleeve. A high-pressure line discharges into the annular chamber, and the annular chamber extends as far as the valve seat face of the valve member. In the annular chamber, the valve member has a pressure shoulder, which is engaged in the opening direction by the pressure prevailing in the annular chamber, while the control pressure prevailing in the inner chamber engages the valve member in the closing direction. The opening motion of the valve member is controlled hydraulically via the control pressure prevailing in the inner chamber. If the pressure prevailing in the annular chamber suffices to open the valve member, counter to the action of a closing spring and of the control pressure, then the injection takes place at the fuel pressure prevailing in the annular chamber.

In this known fuel injection valve, the guide sleeve is an insert body, which is braced between the valve body and a valve holding body and by way of which the high-pressure line discharges into the annular chamber. The insert body also has an annular step on which the closing spring is braced. These structural provisions make the insert body a component that is relatively complex to produce.

### ADVANTAGES OF THE INVENTION

The fuel injection valve of the invention for internal combustion engines having the characteristics of the body of claim 1 has the advantage over the prior art that the guide sleeve serves solely to guide the valve member, and that because of the thrust rod the closing spring can be disposed outside the valve body. The thrust rod in the valve sleeve holder has no sealing function or function of carrying anything away but instead controls only the opening motion of the valve member. The force of the thrust rod acting in the closing direction can be generated by a closing spring, on its thrust end remote from the combustion chamber, by a hydraulic closing force acting on the thrust rod, or by a combination of these.

Further advantages and advantageous features of the subject of the invention can be learned from the description, drawings, and claims.

### DRAWINGS

Exemplary embodiments of the fuel injection valve of the invention are shown in the drawings and described in further detail in the ensuing description. Shown are:

FIG. 1, a first embodiment of the fuel injection valve of the invention, in a longitudinal section;

FIG. 2, an enlarged fragmentary view of the fuel injection valve shown in FIG. 1, in the region of its valve member, in the closed valve position (FIG. 2a) and the open valve position (FIG. 2b);

FIG. 3, a second embodiment of the fuel injection valve of the invention, in a longitudinal section;

FIG. 4, an enlarged fragmentary view of the fuel injection valve shown in FIG. 3, in the region of both of its valve members, in the closed valve position (FIG. 4a), a partly open valve position (FIG. 4b), and a completely open valve position (FIG. 4c).

### DESCRIPTION OF THE EXEMPLARY EMBODIMENTS

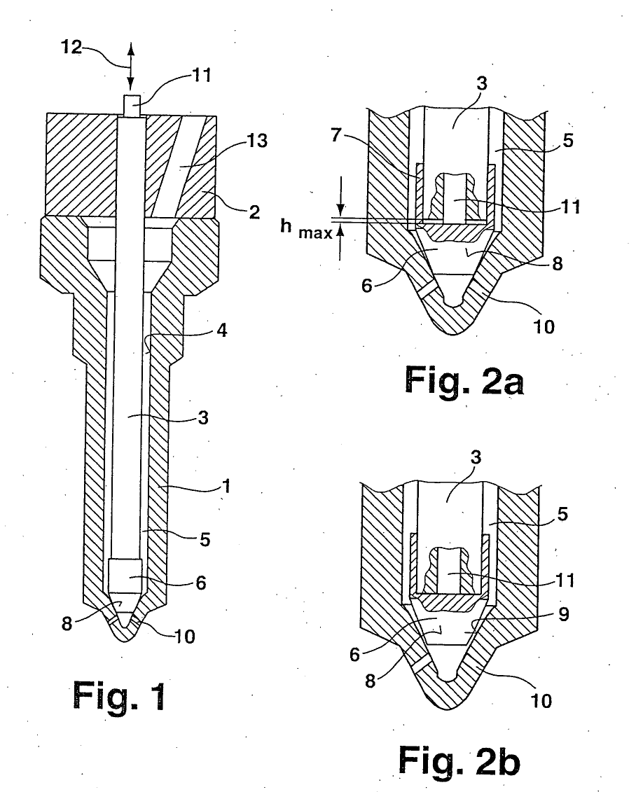

The fuel injection valve for internal combustion engines shown in FIG. 1 has a cylindrical valve body 1, which protrudes with its free lower end into a combustion chamber, not further shown, of the engine to be supplied. By means of a lock nut (not shown), the valve body 1 is braced axially against a valve holding body 2. An axial guide sleeve 3 is disposed in an axial bore 4 of the valve body 1, forming an annular gap 5, and is pressed firmly at its upper end into a bore of the valve holding body 2. A valve member 6 is guided slidably displaceably, with a sleevelike extension 7 (FIG. 2a), on the free end of the guide sleeve 3. On its end toward the combustion chamber, the valve member 6 has a conical valve sealing face 8, which cooperates with a conical valve seat face 9 (FIG. 2b) on the valve body 1. Downstream of the valve seat face 9, injection openings 10 are provided, which open into the combustion chamber. A thrust rod 11 extends in the guide sleeve 3 and is axially displaceable (double arrow 12), in order to control the opening motion of the valve member 6. The thrust rod 11 rests with its lower end on the valve member 6 and is prestressed in the closing direction via a closing force, acting on its upper end, that is generated for instance by a closing spring (not shown) or by a hydraulic control pressure. A high-pressure line 13 discharges into the annular gap 5, and the annular gap extends as far as the valve seat face 9. The cone angle of the valve sealing face 8 and the valve seat face 9 differ, so that in the annular gap 5, the valve sealing face 8 also forms a pressure shoulder, which is engaged in the opening direction by the pressure prevailing in the annular gap 5.

FIG. 2a shows the closed valve position, in which the valve member 6 is pressed with its valve sealing face 8 by the thrust rod 11 against the valve seat face 9 and closes the injection openings 10 provided there. If the fuel pressure prevailing in the annular chamber 5 suffices to open the valve member 6 to the open valve position shown in FIG. 2b counter to the closing force of the thrust rod 11, then the injection takes place at the fuel pressure that prevails in the annular gap 5. The maximum opening stroke hₘₐₓ of the valve member 5 is defined by axial contact of the valve member 5 with the guide sleeve 3.

The valve sealing face 8 is embodied in FIGS. 1 and 2 as a cone face but can also be embodied as a double cone face, in which the more-acute cone angle on the free end is equivalent to the cone angle of the valve seat face 9.

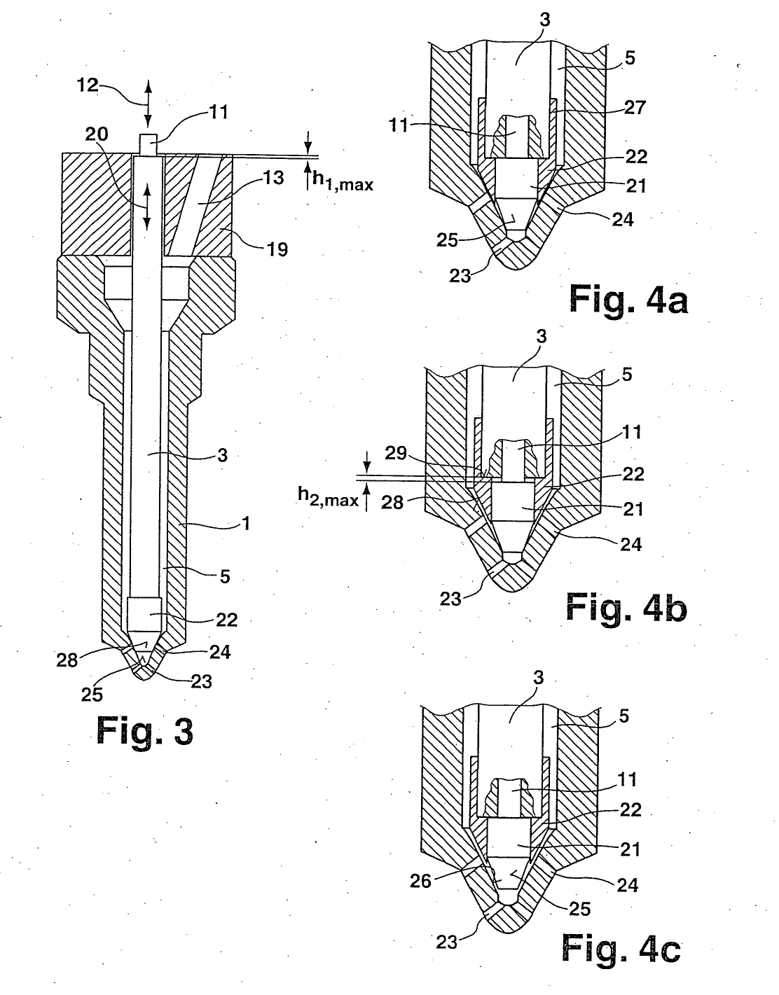

The fuel injection valve shown in FIG. 3 differs from the fuel injection valve in FIG. 1 in that the guide sleeve 3 in the valve holding body 19 is guided axially displaceably (double arrow 20); that the thrust rod 11 controls the opening motion of an inner valve member 21 (FIG. 4a) and the guide sleeve 3 controls the opening motion of a sleevelike outer valve member 22; and that first and second injection openings 23, 24 are provided. The inner valve member 21 is guided axially slidably displaceably in the outer valve member 22 and has a conical valve sealing face 25, which cooperates with a conical valve seat face 26 on the valve body 1. The outer valve member 22 is guided axially slidably displaceably on the guide sleeve 3 by a sleevelike guide extension 27 and has a conical valve sealing face 28 which cooperates with the conical valve seat face 26 on the valve body 1. The cone angles of the valve sealing face 28 and the valve seat face 26 differ, so that in the annular gap 5, the valve sealing face 28 also forms a pressure shoulder, which is engaged in the opening direction by the pressure prevailing in the annular gap 5. The cone angles of the valve sealing face 25 and the valve seat face 26 likewise differ, so that once the outer valve member 22 has lifted from its valve seat, the valve sealing face 25 in the annular gap 5 also forms a pressure shoulder, which is engaged in the opening direction by the pressure prevailing in the annular gap 5. The thrust rod 11 rests with its lower end on the inner valve member 21 and is prestressed in the closing direction via a closing force acting on its upper end, which is generated for instance by a closing spring (not shown) or by a hydraulic control pressure. The guide sleeve 3 rests with its lower face end on an annular step 29 of the outer valve member 22 and is prestressed in the closing direction via a closing force acting on its upper end, which is generated for instance by a closing spring (not shown) or by a hydraulic control pressure.

FIG. 4a shows the closed valve position, in which the outer valve member 22 is pressed by the guide sleeve 3 and the inner valve member 21 is pressed by the thrust rod 11 against the valve sealing face 8 and close the injection openings 23, 24 provided there. If the fuel pressure prevailing in the annular chamber 5 suffices to open the outer valve member 22 into the partly open valve position shown in FIG. 4b counter to the closing force of the guide sleeve 3, then the injection is effected at the fuel pressure prevailing in the annular gap 5, via the upper injection openings 24 that have been opened. The maximum stroke h_{1,max} of the outer valve member 22 is indicated in FIG. 3. If the fuel pressure prevailing in the annular chamber 5 also suffices to open the inner valve member 21 into the fully open valve position shown in FIG. 4c counter to the closing force of the thrust rod 11, then the injection is effected at the fuel pressure prevailing in the annular gap 5, via the opened upper and lower injection openings 23, 24. The maximum stroke h_{2,max} of the inner valve member 21 is defined by contact with the outer valve member 22 and equal to h_{1,max}.

The valve sealing face 25 is embodied in FIGS. 3 and 4 as a cone face but can also be embodied as a double cone face, in which the more-acute cone angle on the free end is equivalent to the cone angle of the valve seat face 26.

1-7. (canceled)

8. A fuel injection valve for internal combustion engines, the valve comprising a valve body, at least one valve member axially displaceable in the valve body a guide sleeve guiding the at least one valve member, a valve sealing face on the end of the valve member toward the combustion chamber of the engine, which sealing face cooperates with a valve seat face on the valve body at least one injection opening in the valve body downstream of the valve seat face and opening into the combustion chamber of the engine, and
a thrust rod disposed in the guide sleeve and controlling the motion of the valve member.

9. The fuel injection valve as defined by claim 8, wherein the maximum opening stroke (hₘₐₓ) of the valve member is defined by the axial contact of the valve member with the guide sleeve.

10. The fuel injection valve as defined by claim 8, further comprising an annular gap formed in the valve body reaching as far as the valve seat face and communicating with a high-pressure line.

11. The fuel injection valve as defined by claim 9, further comprising an annular gap formed in the valve body reaching as far as the valve seat face and communicating with a high-pressure line.

12. The fuel injection valve as defined by claim 8, wherein the valve member is guided slidably displaceably on the guide sleeve.

13. The fuel injection valve as defined by claim 9, wherein the valve member is guided slidably displaceably on the guide sleeve.

14. The fuel injection valve as defined by claim 10, wherein the valve member is guided slidably displaceably on the guide sleeve.

15. The fuel injection valve as defined by claim 11, wherein the valve member is guided slidably displaceably on the guide sleeve.

16. The fuel injection valve as defined by claim 8, wherein the guide sleeve is disposed nondisplaceably in the valve body.

17. The fuel injection valve as defined by claim 9, wherein the guide sleeve is disposed nondisplaceably in the valve body.

18. The fuel injection valve as defined by claim 10, wherein the guide sleeve is disposed nondisplaceably in the valve body.

19. The fuel injection valve as defined by claim 12, wherein the guide sleeve is disposed nondisplaceably in the valve body.

20. The fuel injection valve as defined by claim 8, wherein the guide sleeve is axially displaceable in the valve body.

21. The fuel injection valve as defined by claim 9, wherein the guide sleeve is axially displaceable in the valve body.

22. The fuel injection valve as defined by claim 10, wherein the guide sleeve is axially displaceable in the valve body.

23. The fuel injection valve as defined by claim 12, wherein the guide sleeve is axially displaceable in the valve body.

24. The fuel injection valve as defined by claim 20, comprising an inner and an outer valve member the inner valve member being guided axially slidably displaceably in the outer valve member and having a valve sealing face which cooperates with a valve seat face on the valve body and opens or closes at least one first injection opening, the outer valve member being guided axially slidably displaceably on the guide sleeve and having a valve sealing face which cooperates with a valve seat face on the valve body and opens or closes at least one second injection opening.

25. The fuel injection valve as defined by claim 21, comprising an inner and an outer valve member the inner valve member being guided axially slidably displaceably in the outer valve member and having a valve sealing face which cooperates with a valve seat face on the valve body and opens or closes at least one first injection opening, the outer valve member being guided axially slidably displaceably on the guide sleeve and having a valve sealing face which cooperates with a valve seat face on the valve body and opens or closes at least one second injection opening.

26. The fuel injection valve as defined by claim 22, comprising an inner and an outer valve member the inner valve member being guided axially slidably displaceably in the outer valve member and having a valve sealing face which cooperates with a valve seat face on the valve body and opens or closes at least one first injection opening, the outer valve member being guided axially slidably displaceably on the guide sleeve and having a valve sealing face which cooperates with a valve seat face on the valve body and opens or closes at least one second injection opening.

27. The fuel injection valve as defined by claim 23, comprising an inner and an outer valve member the inner valve member being guided axially slidably displaceably in the outer valve member and having a valve sealing face which cooperates with a valve seat face on the valve body and opens or closes at least one first injection opening, the outer valve member being guided axially slidably displaceably on the guide sleeve and having a valve sealing face which cooperates with a valve seat face on the valve body and opens or closes at least one second injection opening.
